(19) United States
(12) Patent Application Publication
(10) Pub. No.: US 2015/0003103 A1
(43) Pub. Date: Jan. 1, 2015

(54) METHOD, OPTICAL SYSTEM AND LIGHTING ARRANGEMENT FOR HOMOGENIZING LIGHT

(71) Applicant: KONINKLIJKE PHILIPS N.V., EINDHOVEN (NL)

(72) Inventors: Teunis Willem Tukker, Eindhoven (NL); Willem Lubertus Ijzerman, Oss (NL); Sebastianus Adrianus Goorden, Schijf (NL)

(73) Assignee: KOINKLIJKE PHILIPS 5, EINDHOVEN (NL)

(21) Appl. No.: 14/375,170

(22) PCT Filed: Jan. 25, 2013
(86) PCT No.: PCT/IB13/50665

§ 371 Date: Jul. 29, 2014

Related U.S. Application Data
(60) Provisional application No. 61/593,396, filed on Feb. 1, 2012.

(51) Int. Cl. G02B 27/09; F21V 8/00

(52) U.S. Cl. CPC G02B 27/0927; G02B 6/0096
USPC 362/551

(57) ABSTRACT

A method, an optical system and a lighting arrangement for homogenizing a bundle of light rays (110) by means of an elongated optical element (100) arranged for homogenizing light. The bundle of light rays is directed into a transversal entry face (101) of the optical element, and into at least one of the following geometrical regions: (a) a neighbourhood of the perimeter of the entry face; (b) a neighbourhood of at least a portion of a first line segment (R1) extending from the centre of the entry face to a mid-point of a vertex (123); (c) a neighbourhood of at least a portion of a second line segment (R2a) extending from the centre of the entry face to a midpoint of an edge (122).

### FIELD OF THE INVENTION

The present invention generally relates to the field of optical components. More precisely, it relates to a method, an optical system and a lighting arrangement for homogenizing a bundle of light rays.

### BACKGROUND OF THE INVENTION

Numerous systems in various fields of industry require a provision of a beam of light which is homogeneous (uniform) across the span of the light beam, in terms of properties such as a illuminance and/or colour. For example, in many medical applications such as laser therapy, laser bio-stimulation, and photo-dynamic therapy, it is highly desirable that the light beam has a homogeneous illuminance in the output profile of the light beam. As most light sources, however, emit a light which is non-homogeneous, light filtering and/or devices of light correction have been proposed to obtain the sought homogeneity of the light.

In a case where the light is generated from a plurality of light sources (e.g. LEDs with different colours), a mixing of the light may be performed with the aim of rendering a homogeneous light. The mixing of the light may be carried out by guiding the light from the plurality of light sources through an optical guide. Embodiments of optical guides are solid mixing rods (e.g. a glass/plastic fiber, rod, tube, or the like), utilizing the total internal reflection (TIR) at the interfaces towards the surrounding medium (reflection back and forth), such that the light reflected within the mixing rod has been mixed when exiting the mixing rod.

The structure of the mixing rod is of importance to obtain a preferred mixing of the light, and various geometrical structures of the mixing rods have been proposed for this purpose. From practice, it is known that mixing rods having square cross-sections are superior to circular ones, but that rods with hexagonal cross-sections are even better for the purpose of obtaining a uniform light. Although hexagonal mixing rods are widely used nowadays, this geometrical shape does not provide an adequate homogeneity of the illuminance at the exit face of the mixing rod. More specifically, the light rays are not adequately mixed in the far field of the mixing rod since the mixing does not sufficiently alter the angles of the light rays.

Furthermore, the ability of the mixing rod to mix the light is dependent on how the light from the plurality of light sources is directed into the mixing rod. More specifically, the directing of the light into the mixing rod is dependent on the geometrical shape of the mixing rod, although the precise relationship between mixing efficiency and light incidence points have not been fully explored and reduced to practice.

In view of this, there is a wish to provide an improved mixing of the light.

### SUMMARY OF THE INVENTION

It is an object of the present invention to provide a method, an optical system and a lighting arrangement for homogenizing a bundle of light rays. This and other objects are achieved by a method, an optical system and a lighting arrangement having the features set forth in the independent claims. Preferred embodiments are defined in the dependent claims.

Hence, according to a first aspect of the present invention, there is provided a method for homogenizing a bundle of light rays by means of an elongated optical element arranged for homogenizing light. The method comprises the step of directing the bundle of light rays into a transversal entry face of the optical element, having a cylinder shape. The entry face comprises at least two edges of zero curvature, and vertices between any two adjacent ends of the at least two edges, wherein at least one of the vertices is a segment with positive curvature. Furthermore, the method comprises the step of directing the bundle of light rays into at least one of the following geometrical regions: (a) a neighbourhood of the perimeter of the entry face; (b) a neighbourhood of at least a portion of a first line segment extending from the centre of the entry face to a midpoint of a vertex; and (c) a neighbourhood of at least a portion of a second line segment extending from the centre of the entry face to a midpoint of an edge. The method further comprises the step of extracting the bundle of light rays from an exit face of the optical element.

According to a second aspect of the present invention, there is provided an optical system for homogenizing a bundle of light rays. The optical system comprises an elongated optical element having a cylinder shape, arranged for mixing light. The optical element comprises a transversal entry face and a transversal exit face. The entry face has a perimeter comprising at least two edges of zero curvature, and vertices between any two adjacent ends of the at least two edges, wherein at least one of the vertices is a segment with positive curvature. The optical system further comprises at least one light source arranged at the entry face, wherein the light source is arranged for directing the bundle of light rays into the entry face. The optical system may comprise two or more light sources, e.g., light sources emitting light with different properties which it is desired to mix into one homogeneous bundle. The bundle of light rays is directed into at least one of the above geometrical regions (a), (b) and (c).

According to a third aspect of the present invention, there is provided a lighting arrangement comprising at least one light source adapted to emit a bundle of light rays. The light source or sources are arranged along at least one of the following geometries: a perimeter of a polygon; at least a portion of a first line segment extending from a centre to a vertex of a polygon; and at least a portion of a second line segment extending from a centre to a midpoint of an edge of a polygon. The polygon substantially coincides with the shape of an entry face of an optical element, arranged to homogenize a bundle of light rays emitted by the at least one light source. The optical element has a cylinder shape, and comprises a transversal entry face and a transversal exit face. The entry face has a perimeter comprising at least two edges of zero curvature, and vertices between any two adjacent ends of the at least two edges, and wherein at least one of the vertices is a segment with positive curvature. The at least one light source directs the bundle of light rays into at least one of the geometrical regions (a), (b) and (c) of the optical element.

Thus, the present invention is based on the idea of homogenizing a bundle of light rays by directing the bundle of light rays into the entry face of an elongated optical element having a cylinder shape. The vertices between the edges have positive curvature, i.e. the vertices are outwardly curved/rounded. By the term “zero curvature”, it is here meant that the edges of the entry face are even/straight, i.e. not curved in the plane of the entry face. Furthermore, by the term “vertices”, it is here meant corners/angles between the edges of the entry face of the optical element. By the term “positive curvature”, it is here meant that the at least one vertex is rounded outwards from the perimeter (i.e. bulging convexly outwards). By the term “polygon”, it is here meant that the perimeter is defined by even/straight edges, but wherein the corners/angles between the edges of the perimeter are rounded. When light rays are directed into the optical element and are reflected therein, the curved vertices of the optical element lead to an improved mix of the light rays in the optical element, compared to a mixing rod without rounded corners/vertices. The purposefully shaped perimeter of the optical element enhances/increases the irregularity/chaos of the mixing of the light within the optical element.

Based on the described optical element of the present invention, it will be appreciated that the inventors have realized a way of directing of the light into the entry face of the optical element, which provides an increased homogeneity of the light at the exit face of the optical element than if the light entered the entry face at random locations. This increased homogeneity of the light is achieved by directing the bundle of light rays into one or more of the geometrical regions (a), (b) and (c).

The present invention is advantageous in that an increased homogeneity of the light is provided by selectively directing the bundle of light rays into specific geometrical regions of the entry face of the optical element, dependent on the geometric shape of the entry face. The inventors have realized that the optical element may provide a highly mixed/homogenized light after the bundle of light rays has passed through the optical element, dependent on where the light incides on the entry face with respect to its geometrical shape. Furthermore, the inventors have realized that other regions of the entry face, into which the bundle of light rays may be directed, will instead provide a poor mixing/homogenization of the light. Hence, the present invention provides the advantage of an improved homogenization of the light, which is obtained by a purposeful directing of the light into the entry face of the optical element. Furthermore, it will be appreciated that the positions of the geometrical regions of the entry face, into which the light may be directed for an increased homogeneity of the light, are not obvious to a person skilled in the art of optics. On the contrary, the present invention suggests to direct light into specific regions of the entry face of the optical element which the skilled person would not contemplate when given the task of providing an improved mixing of the light. Hence, the directing of the light into the optical element, as described in the present invention, provides a surprising effect related to the homogenization of the light.

The method for homogenizing a bundle of light rays by means of an elongated optical element arranged for homogenizing light comprises the step of directing the bundle of light rays into the transversal entry face of the optical element. By the term “directing”, it is here meant that the bundle of light rays is oriented towards the entry face. For example, one or more light sources may be positioned immediately adjacent to the entry face, such that the light from the light sources is directed directly into the entry face. Alternatively, the light may be guided (e.g. by optical guiding means) towards the entry face of the optical element.

The bundle of light rays is directed into at least one of the geometrical regions (a), (b) and (c). By the term “neighbourhood of the perimeter”, it is here meant a region in a peripheral portion (the periphery) of the entry face. Furthermore, “a neighbourhood of at least a portion of a line segment” refers to a region in the proximity of the portion of a line segment.

The method further comprises the step of extracting the bundle of light rays from an exit face of the optical element. In other words, after the bundle of light rays has passed through the optical element, the homogenized light is extracted from the exit face of the optical element, opposite the entry face.

With reference to the geometric regions discussed above, it is preferable that region (b) is located in an entry face substantially shaped as an odd-numbered polygon. Further, region (c) is preferably located in an entry face substantially shaped as an even-numbered polygon. Similarly, with reference to lighting arrangements according to embodiments of the invention, it is preferable that said one or more light sources are arranged along at least a portion of a first line segment extending from a centre to a vertex of an odd-numbered polygon. Alternatively, such lighting arrangements may comprise one or more light sources arranged along at least a portion of a second line segment extending from a centre to a midpoint of an edge of an even-numbered polygon.

According to an embodiment of the present invention, and most preferably in the case where the entry face is an even-numbered polygon, the bundle of light rays may be directed into a neighbourhood of at least one portion of a second line segment, wherein the at least one portion extends between the midpoint of the second line segment to a midpoint of an edge. Hence, the bundle of light rays may be directed into a neighbourhood of the portion of the second line segment from the midpoint of the line segment (i.e. a midpoint on the radius) to the midpoint of the edge. This is particularly efficient if the optical element has an entry face shaped as an even-numbered polygon. The present embodiment is advantageous in that an increased homogeneity of the light is provided if light is directed into this specific geometrical region, in the case where the entry face has the shape of a even-numbered polygon.

According to an embodiment of the present invention, the bundle of light rays may be directed outside a central region of an even-numbered polygon. Hence, in a case where the optical element has an entry face in the shape of a rectangle, and in particular a square, the bundle of light rays may be directed outside (i.e. not into) a central region of the entry face. The inventors have come to the astonishing conclusion that light directed into the central region of an entry face having the shape of a rectangle, will only be homogenized to a limited extent (or not at all). Hence, the present embodiment is advantageous in that the light, as extracted from the exit face of the optical element, may be even further homogenized if one refrains from directing the bundle of light rays into the centre of the entry face but instead directs the light into other regions of the entry face according to the described embodiments.

According to an embodiment of the present invention, the number of edges of the even-numbered polygon may be four, six or eight. Analogously, according to another embodiment of the present invention, the number of edges of the odd-numbered polygon may be three, five or seven.

According to an embodiment of the present invention, the bundle of light rays may be directed outside a central region of an odd-numbered polygon, wherein the number of edges of the odd-numbered polygon is seven. Analogously with the case of entry faces of even-numbered polygons, the inventors have realized that light, directed into the central region of an entry face of a polygon with five or seven edges, will only be homogenized to a limited extent or, possibly, not at all. Hence, the present embodiment is advantageous in that a more homogenized light may be obtained if one refrains from directing the bundle of light rays into this region of the entry face, but instead directs the light into other regions of the entry face according to the described embodiments.

According to an embodiment of the present invention, the length of the vertices may constitute at least 1% and at most 90% of the length of the perimeter. In other words, the length of the curved vertices represents 1-90% of the entire length of the perimeter defined by the edges and the vertices between any two adjacent ends of the edges. The present embodiment is advantageous in that the elongated optical element provides an improved mixing of a bundle of light rays compared to both an optical element with perfectly sharp corners and a round (or nearly round) entry face. Hence, a more homogeneous light is obtained after the bundle of light rays has passed through the optical element of the present invention, compared to existing mixing rods.

The features of the optical element of the present invention are advantageous in that the element provides an improved mixing of a bundle of light rays, such that a more homogeneous light is obtained after the bundle of light rays has passed through the optical element, compared to existing mixing rods. More specifically, the edges and the vertices of the optical element, wherein the vertices have positive curvature, provide an enhanced mixing of the light due to an improved scattering/reflection of the light within the optical element. This is realized as the perimeter of the optical element, comprising rounded/curved vertices, increases the number of directions of the light ray reflection/scattering as the normal angle of the curved vertices varies continuously. It will be appreciated that in an optical element with a transversal cross-section comprising only straight edges, a ray direction can generally only change by multiples of 2π/n, where n is the number of edges. In contrast, the optical element of the present invention decreases the number of stable trajectories of the reflected light, i.e. trajectories of the light ray reflections having a periodic propagation within the optical element, and provides a more homogeneous light (i.e. even distribution of the light components) at the exit face of the optical element with respect to one or more of e.g. luminous intensity, colour point, wavelength spectrum, etc, compared to mixing rods in the prior art.

The features of the optical element of the present invention are further advantageous in that the improved mixing of the light is provided solely by the geometrical shape of the optical element. In other words, the enhanced homogeneity of the light is obtained merely by the geometrical features of the optical element, such that additional measures for the purpose of improving the mixing of the light (e.g. a coating or other treatments of the inside of the optical element and/or a provision of auxiliary elements to the optical element for the purpose of improving the reflectivity) may be rendered superfluous. Consequently, the optical element of the present invention is easy to manufacture, as the optical element may be produced merely from the material which has the purpose of guiding and mixing the light (e.g. a transparent material comprising glass, plastic, or the like), thereby omitting the need of other (auxiliary) materials. Moreover, as additional treatments (e.g. inside coatings) may be refrained from, rendering the manufacture of the optical element of the present invention relatively inexpensive. Since the element may be manufactured from a single material, the optical element is easily recyclable.

Another advantage associated with the features of the optical element of the present invention is that the geometry of the transversal cross-section of the optical element further provides an earlier homogeneity of the bundle of light rays in a direction from the entry face to the exit face of the optical element compared to known mixing rods. In other words, a bundle of light rays led into the entry face of the optical element is quickly mixed along the elongated optical element due to the optimized perimeter of the transversal cross-section according to the optical element of the present invention. The optical element is able to achieve the task of mixing the initially non-homogeneous bundle of light rays into a homogenized light earlier along its elongation compared to mixing rods in the prior art. Hence, the optical element of the present invention may have a relatively shorter length than other mixing rods in the prior art to fulfil this given task. This is highly advantageous, as the optical element thereby implies an even lower manufacture costs of the optical element, a lower weight, a more convenient handling and/or transportation, and/or a simplified procedure if the optical element is to be mounted into an optical system.

A cylinder-shaped optical element with the features according to the present invention is advantageous in that it is easily manufactured, e.g. by using extrusion. Furthermore, the cylinder-shape of the optical element is advantageous in a case the length of the optical element needs to be changed. For example, if the optical element is shortened, the cross-section of the exit face, as well as the cross-section between the entry face and the exit face will still be the same. Hence, the length of the optical element may be adapted more easily according to the required/sought mixing of the light.

At least one of the vertices of the optical element may be a segment of a circular arc. In other words, the at least one vertex is a portion of the circumference of a circle. The present embodiment is advantageous in that the vertex has a continuous and symmetric rounding which even further contributes to the mixing of the light.

The radius of the circular arc of the optical element may be equal to the length of at least one of the at least two edges. The present embodiment is advantageous in that it decreases the number of stable trajectories of light ray reflections within the transversal cross-section of the optical element, as can be verified by numerical simulations. For example, if the cross-section of the optical element has a polygon shape with an odd number of edges, only one stable trajectory exists between the segment of the circular arc and the opposing edge having the same length as the radius of the circular arc. Hence, the present embodiment contributes to an even more improved mixing of the light.

The radius of the circular arc of the optical element may be greater than the length of at least one of the at least two edges. An advantage of the present embodiment is that it even further decreases the number of stable trajectories of light ray reflections within the optical element. For example, if the transversal cross-section of the optical element has a polygon shape with an odd number of edges, no stable trajectory exists between the segment of the circular arc and the opposing edge, wherein the radius of the circular arc is greater than the opposing edge. Hence, the present embodiment even further contributes to an improved mixing of the light.

All of the at least two edges of the optical element may be of equal length and all of the vertices are of equal length. In other words, the transversal cross-section of the optical element is equilateral with respect to its edges, and the vertices between any two adjacent ends of the edges are of equal length. The present embodiment is advantageous in that the optical element provides an n-fold rotational symmetry (wherein n is the number of edges). Consequently, an alignment of the optical element is facilitated, e.g. when mounting the optical element in an optical system.

The gradient of at least one of the vertices and the gradient of any two adjacent ends of the edges of the optical element may be equal at at least one point of intersection between the at least one of the vertices and any two adjacent ends. In other words, the vertex between two adjacent ends provides a smooth rounding/connection/patching between the edges, wherein the gradient of any point on the vertex is within the interval bounded by the gradients of the two adjacent ends and equal at the points of intersection.

The perimeter of the optical element may comprise six edges. In other words, the six edges constitute an hexagonal cross-section of the optical element, further comprising rounded vertices between the edges. The present embodiment is advantageous in that the mixing of the light by the optical element of the present embodiment is superior to the mixing which is achieved by mixing rods in the prior art having merely a hexagonal cross-section without rounded corners. This is realized as the rounded vertices in the hexagonal cross-section of the present embodiment increases the number of possible/distinct light ray reflections within the optical element. Furthermore, as mixing rods with hexagonal cross-sections are known in the prior art, the present embodiment is further advantageous in that the equipment for the manufacture of the mixing rods from the prior art is easily modified for the manufacture of the optical element according to the present embodiment, wherein the hexagonal cross-section further comprises rounded vertices to provide an improved mixing of the light.

The perimeter of the optical element may be defined by three edges wherein two edges are perpendicular and of equal length, the vertices being three circular arcs of equal radius, and wherein the radius is equal to the length of one of the two edges. In other words, the transversal cross-section of the optical element is shaped as a right-angled triangle, having two perpendicular edges as catheti and one edge as hypotenuse, but wherein the vertices are rounded such that no sharp corners exist. Further, the vertices are circular arcs having the same radius, wherein the radius is equal to the length of one of the two edges (catheti). As stable trajectories of light ray reflections are known to exist in any transversal cross-section that has n-fold rotational symmetry (wherein n is an integer), only one stable trajectory of light ray reflections is present in an optical element having the perimeter as defined in the present embodiment. Hence, an advantage with the present embodiment is that the homogeneity of the light at the exit face of the optical element is even further increased. It will be appreciated that the specific embodiments and any additional features described above with reference to the method are likewise applicable and combinable with the optical system according to the second aspect of the present invention and the lighting arrangement according to the third aspect of the present invention.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

These and other aspects of the present invention will now be described in more detail, with reference to the appended drawings showing embodiment(s) of the invention.

FIG. 1 is a schematic illustration of an elongated optical element according to an embodiment of the present invention;

FIGS. 2a-b are schematic illustrations of transversal cross-sections of optical elements; and

FIGS. 3a-f are schematic illustrations of different entry faces of optical elements.

### DETAILED DESCRIPTION OF THE EMBODIMENTS

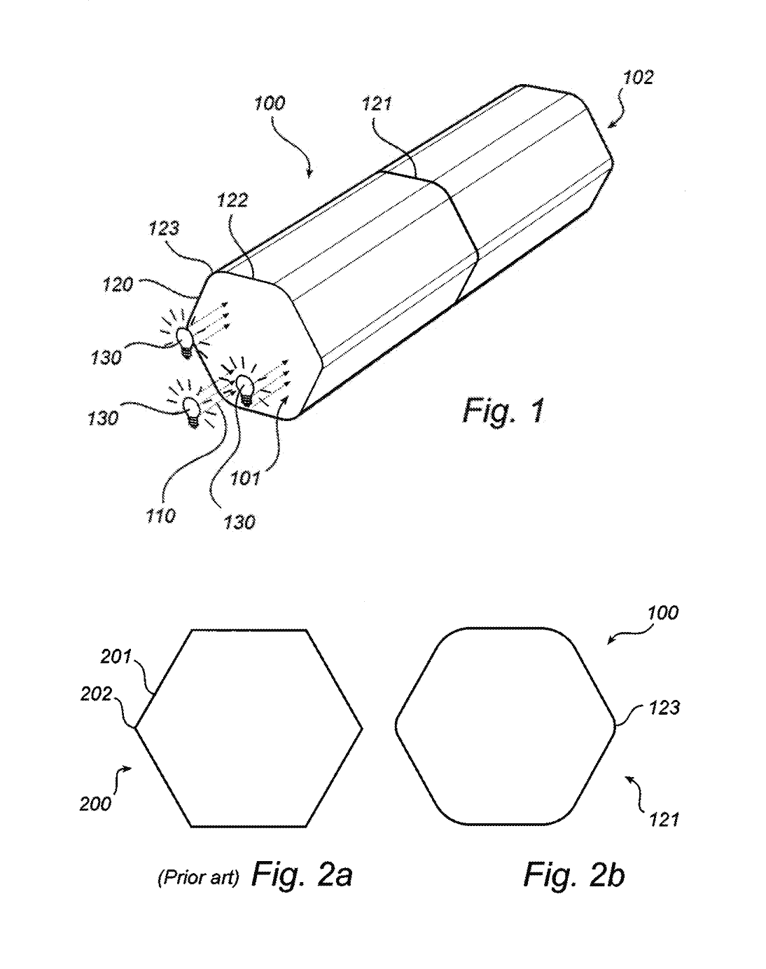

FIG. 1 is a schematic illustration of an elongated optical element 100. The optical element 100, which may be made of a transparent material like glass or plastic, is shaped as a cylinder and comprises a entry face 101 and an exit face 102. At operation, a bundle of light rays 110 is directed towards the entry face 101, wherein the bundle of light rays 110 undergoes total internal reflection (TIR) at the interfaces towards the surrounding medium. After being reflected within the optical element 100, the bundle of light rays 110 exits the optical element 100 through the exit face 102.

The contour of the optical element 100 in FIG. 1 is designed such that the perimeter 120 of a transversal cross-section 121 of the optical element 100 is defined by six edges 122 of zero curvature and six vertices 123 between any two adjacent ends of the edges 122. In the present embodiment, the edges 122 are of equal length and the vertices 123 are of equal length. The vertices 123 are segments with positive curvature (rounded segments), wherein the lengths of the vertices 123 in FIG. 1 constitute 30-50% of the length of the perimeter 120. When the bundle of light rays 110 from the light source(s) 130 is directed into the optical element 100, the curved/rounded vertices 123 of the optical element 100 lead to an improved mix of the angles and positions of the light rays in the optical element 100, compared to a mixing rod without rounded corners/vertices. The corners/vertices 123 may alternatively be referred to as rounded ridges 123 extending longitudinally in the optical element 100. Due to the rounded edges, the optical element 100 provides an increased homogeneity of the bundle of light rays 110 when this leaves the optical element 100 by the exit face 102.

The light sources 130 may e.g. comprise several LEDs with different colour (e.g. one or more white LEDs wherein red LEDs may further be provided for improving the colour rendering index (CRI)) wherein the LEDs may further be comprised in a tuneable LED spotlight. Furthermore, a collimating means may be arranged at the exit face 102 of the optical element for collimating the bundle of light rays exiting the optical element into a beam of a required/desired shape. Examples of a collimating means may be a lens, a Söller collimator or a TIR collimator.

FIG. 2a is a schematic illustration of a transversal cross-section 200 of a mixing rod according to the prior art, wherein the cross-section 200 is hexagonal, comprising six edges 201 and six corners 202. However, the geometrical shape of the cross-section 200 as disclosed does not provide the desired homogeneity of the illuminance at the exit face of the mixing rod. More specifically, the light rays are not adequately mixed in the far field of the mixing rod since the mixing does not sufficiently alter the angles of the light rays.

FIG. 2b is a schematic illustration of the transversal cross-section 121 of the optical element 100 according to FIG. 1. Compared to the sharp corners 202 of the cross-section 200 as shown in FIG. 2a, the vertices 123 of the optical element 100 are segments with positive curvature. As a result, the cross section 121, comprising the vertices 123, provides an improved mixing of a bundle of light rays directed into the optical element 100 compared to the use of an optical element with the cross-section 200.

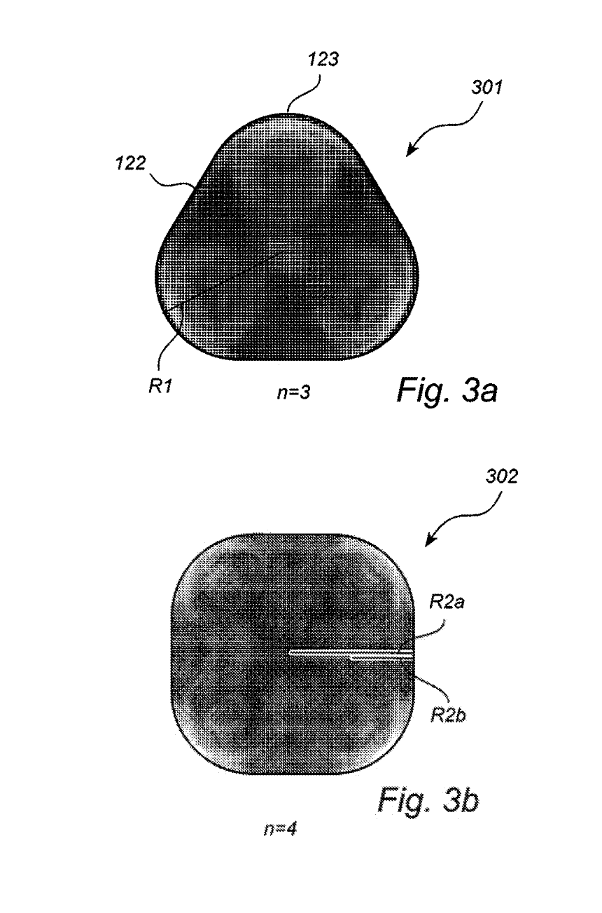

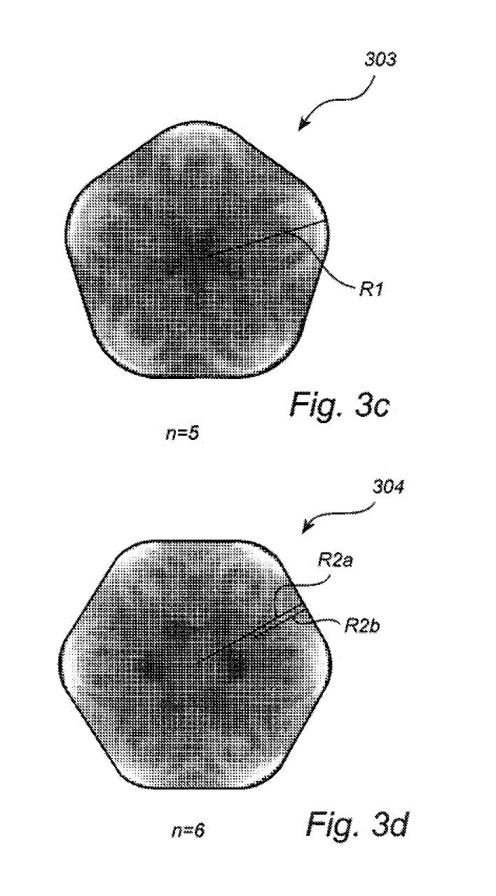

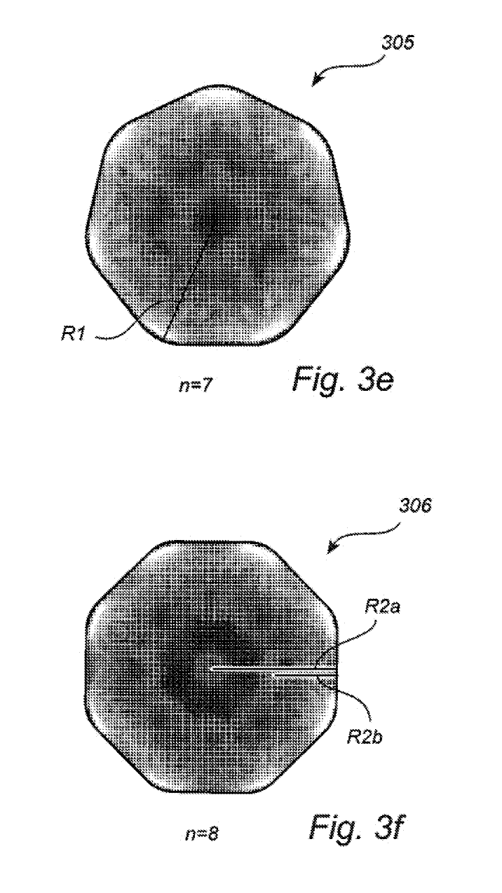

FIGS. 3a-f are schematic illustrations of different entry faces 301-306 of optical elements 100 of the present invention. The entry face 301 comprises three edges 122 (n=3), the entry face 302 comprises four edges (n=4) etc., and the entry face 306 comprises eight edges (n=8). The entry faces 301-306 further comprise rounded vertices 123 between the edges, wherein edges 122 and vertices 123 carry reference numerals only in entry face 301 for simplicity reasons.

As previously described, it will be appreciated that the optimal positioning of the light sources 130 (e.g. LEDs) at an entry face of an optical element 100 depends on the geometry of the entry face. Associated with this observation, FIGS. 3a-f indicate the geometrical regions of each entry face 301-306 into which a bundle of light rays may be directed, wherein dark/black regions and light/white regions correspond to a minimal homogenization and a maximal homogenization, respectively. Hence, the light/white regions in FIGS. 3a-f indicate the geometrical regions of each entry face 301-306 into which a bundle of light rays may be directed for providing a highly mixed/homogenized light at the exit face 102, after the bundle of light rays 110 has passed through the optical element 100. Analogously, the dark/black regions indicate the geometrical regions of each entry face 301-306 into which a bundle of light rays may be directed, but in which regions the light will not be efficiently mixed/homogenized. The geometrical regions, providing patterns of high/low homogenizing of the light, have been determined experimentally.

For all entry faces 301-306, highly homogeneous light is obtained using the optical element 100 if a bundle of light rays is directed into at least a neighbourhood of the perimeter (i.e. in a region in a peripheral portion).

Furthermore, the shading pattern in the entry faces 301, 303, 305, having shapes of odd-numbered polygons (n=3, 5, 7, respectively), shows that the light may be highly homogenized if the bundle of light rays is directed into a neighbourhood of a first line segment R1, extending from the centre of the entry faces 301, 303, 305 to a midpoint of a vertex 123. Moreover, for the entry face 301, the bundle of light rays may be directed into a central region of the entry face 301 for a high homogenization of the light.

Furthermore, the shading pattern in the entry faces 302, 304, 306, having shapes of even-numbered polygons (n=4, 6, 8, respectively), shows that the light may be highly homogenized if the bundle of light rays 110 is directed into a neighbourhood of a second line segment R2a, extending from the centre of the entry faces 302, 304, 306 to a midpoint of an edge 122. More specifically, the bundle of light rays may be directed into a neighbourhood of the portion R2b of the second line segment R2a from the midpoint of the second line segment R2a (i.e. an approximate midpoint on the radius) to the midpoint of the edge 122.

Furthermore, in the case of an optical element 100 with an entry face 302, shaped as a rectangle, the bundle of light rays may be directed outside (i.e. not into) a central region of the entry faces 302, as light directed into these regions will not be efficiently homogenized. Here, the central regions of the entry faces 302, which only to a limited extent contribute to the homogenizing of the light if light is directed into these central regions, correspond approximately to a central, circular area with a radius between ⅓ and ½ of the radius R2a. Analogously, in the case of an optical element 100 with the entry face 303 or the entry face 305 (i.e. n=5 or 7), the bundle of light rays may be directed outside its central region for a high homogenization of the light.

It is considered within the abilities of the person skilled in the art to derive further advantageous embodiments from the experimental data plotted in FIGS. 3a-f. In these figures, brighter shaded areas correspond to regions of the entry face for which an incident light bundle will be more efficiently mixed and which the skilled person will prefer. However, the darker shaded areas correspond to entry face regions that are less suitable as incidence areas if efficient light mixing is desired. Hence, the scope of the present invention is not limited to that of the claims, and protection is also sought for further light mixing methods developed on the basis of the experimental data shown in FIG. 3; for light-mixing optical elements with the geometric properties described herein; for arrangements of light sources adapted to suit a particular light-mixing optical element in view of the experimental data in FIG. 3; and for optical systems comprising at least one light-mixing optical element and an arrangement of light sources which is attached or attachable in a fixed spatial relationship to the light-mixing element to ensure efficient light mixing.

Even though the invention has been described with reference to specific exemplifying embodiments thereof, many different alterations, modifications and the like will become apparent to those skilled in the art after studying this description. The described embodiments are therefore not intended to limit the scope of the invention, which is only defined by the appended claims. For example, in FIG. 1, the relationship between the diameter of the entry face 101 and the length of the elongated optical element 100 may be different from that shown. For example, the optical element 100 may be thinner (longer) or thicker (shorter) in relation to the entry face 101, such that the ratio between the length of the optical element 100 and the entry face 101 becomes larger or smaller, respectively. Furthermore, in FIG. 2b, the vertices 123 may constitute a greater or a smaller portion of the length of the perimeter 120 than that shown. It will also be appreciated that the number of elements shown/described may vary. For example, the three light sources 130 in FIG. 1 may alternatively be any number of light sources.

1. An optical system for homogenizing a bundle of light rays, comprising:
an elongated optical element having a cylinder shape, arranged for homogenizing light, said optical element comprising a transversal entry face and a transversal exit face, said entry face having a perimeter shaped as a convex polygon and comprising at least two edges of zero curvature, and vertices between any two adjacent ends of said at least two edges, and wherein at least one of the vertices is a segment with positive curvature, the length of which constitutes at least 1% and at most 90% of the length of said perimeter, and
at least one light source arranged at said entry face and arranged for directing said bundle of light rays into said entry face, wherein said bundle of light rays is directed into at least one of the following geometrical regions:
(a) a neighbourhood of said perimeter of said entry face;
(b) a neighbourhood of at least a portion of a first line segment extending from the centre of said entry face to a midpoint of a vertex;
(c) a neighbourhood of at least a portion of a second line segment extending from the centre of said entry face to a midpoint of an edge.

2. The optical system as claimed in claim 1, wherein region (b) is located in an entry face shaped substantially as a polygon with an even number of vertices and region (c) is located in an entry face shaped substantially as a polygon with an odd number of vertices.

3. The optical system as claimed in claim 1, wherein said bundle of light rays (110) is directed into a neighbourhood of a portion of said second line segment, said at least one portion extending at most between the midpoint of said line segment to a midpoint of an edge.

4. The optical system as claimed in claim 1, wherein said bundle of light rays is directed outside a central region of an even-numbered polygon.

5. The optical system as claimed in claim 1, wherein the number of edges of said even-numbered polygon is four, six or eight.

6. The optical system as claimed in claim 1, wherein the number of edges of said odd-numbered polygon is three, five or seven.

7. The optical system as claimed in claim 1, wherein said bundle of light rays is directed outside a central region of an odd-numbered polygon, wherein the number of edges of said odd-numbered polygon is five or seven.

8. A lighting arrangement comprising at least one light source adapted to emit a bundle of light rays, wherein said at least one light source is arranged along at least one of the following geometries:
(a′) a perimeter of a convex polygon;
(b′) at least a portion of a first line segment extending from a centre to a vertex of a polygon; and
(c′) at least a portion of a second line segment extending from a centre to a midpoint of an edge of a polygon;
and wherein said convex polygon substantially coincides with the shape of an entry face of an optical element, arranged to homogenize a bundle of light rays emitted by said at least one light source, said optical element having a cylinder shape, comprising a transversal entry face and a transversal exit face, said entry face having a perimeter shaped as a convex polygon and comprising at least two edges of zero curvature, and vertices between any two adjacent ends of said at least two edges, and wherein at least one of the vertices is a segment with positive curvature, the length of which constitutes at least 1% and at most 90% of the length of said perimeter, so that said at least one light source directs said bundle of light rays into at least one of the following, respective geometrical regions of said optical element:
(a) a neighbourhood of the perimeter of said entry face;
(b) a neighbourhood of at least a portion of a first line segment extending from the centre of said entry face to a midpoint of a vertex; and
(c) a neighbourhood of at least a portion of a second line segment extending from the centre of said entry face to a midpoint of an edge.

9. A method for homogenizing a bundle of light rays using an elongated optical element arranged for homogenizing light, said method comprising the steps of:
directing said bundle of light rays into a transversal entry face of an elongated optical element having a cylinder shape, said entry face having a perimeter shaped as convex polygon and comprising at least two edges of zero curvature, and vertices between any two adjacent ends of said at least two edges, wherein at least one of the vertices is a segment with positive curvature, the length of which constitutes at least 1% and at most 90% of the length of said perimeter, and
directing said bundle of light rays into at least one of the following geometrical regions:
(a) a neighbourhood of said perimeter of said entry face;
(b) a neighbourhood of at least a portion of a first line segment extending from the centre of said entry face to a midpoint of a vertex;
(c) a neighbourhood of at least a portion of a second line segment-(extending from the centre of said entry face to a midpoint of an edge; and
extracting said bundle of light rays from an exit face of said optical element.

10. The method as claimed in claim 9, wherein region (b) is located in an entry face shaped substantially as a polygon with an odd number of vertices and region (c) is located in an entry face shaped substantially as a polygon with an even number of vertices.

11. The method as claimed in claim 9, wherein said bundle of light rays is directed into a neighbourhood of a portion of said second line segment, said at least one portion extending at most between the midpoint of said second line segment to a midpoint of an edge.

12. The method as claimed in claim 9, wherein said bundle of light rays is directed outside a central region of an entry face being a rectangle.

13. The method as claimed in claim 9, wherein the number of edges of said even-numbered polygon is four, six or eight.

14. The method as claimed in claim 9, wherein the number of edges of said odd-numbered polygon is three, five or seven.

15. The method as claimed in claim 9, wherein said bundle of light rays is directed outside a central region of an odd-numbered polygon, wherein the number of edges of said odd-numbered polygon is five or seven.
